(19) United States
(12) Patent Application Publication
(10) Pub. No.: US 2013/0295347 A1
(43) Pub. Date: Nov. 7, 2013

(54) METHOD FOR PRODUCING A COMPOSITE PANEL AND COMPOSITE PANEL

(71) Applicant: Jan Verhaeghe, Beveren (BE)

(72) Inventor: Jan Verhaeghe, Beveren (BE)

(73) Assignee: GROEP STEVENS INTERNATIONAL, Lokeren (BE)

(21) Appl. No.: 13/819,792

(22) PCT Filed: Aug. 30, 2011
(86) PCT No.: PCT/EP2011/064920

§ 371 Date: Jul. 10, 2013

(30) Foreign Application Priority Data
Aug. 31, 2010 (EP) 10174724.4

(51) Int. Cl. B32B 7/04; B29C 65/72; B32B 38/10; B32B 37/14

(52) U.S. Cl. CPC B32B 7/045; B32B 37/14; B29C 65/72; B32B 38/10
USPC 428/201; 156/247; 156/93; 216/36

(57) ABSTRACT

A method for producing a composite sandwich panel wherein a core is inserted between a first and a second sheet of a fibrous reinforcing material, wherein the first and the second sheet and the core are connected to each other by means of connecting fibrous reinforcing material to produce a sandwich structure, wherein the sandwich structure is impregnated with a resin and wherein at least part of the core is removed after the connecting fibrous reinforcing material has been impregnated with resin and the resin has hardened at least partly.

The present application relates to a method for producing a composite sandwich panel, according to the preamble of the first claim. The present application also relates to a composite sandwich panel.

### BACKGROUND OF THE INVENTION

Parts made in composite material offer a wide variety of mechanical and other properties, not attainable with metal parts. As a result, composite sandwich structures having one or more face sheets of fibrous reinforcing material adhered to a core material e.g. a plastic foam or a honeycomb structure, find a wide variety of applications in a.o. aerospace, automotive, marine, construction, etc. where mechanical properties are of utmost importance. In these applications use is made of the advantages that sandwich structures are usually lighter than their solid metal or solid composite counterparts, that they may show higher strength and stiffness than metallic parts, a desirable strength to weight ratio and that they often are inert to a wide variety of chemicals and environmental threats. Composite sandwich structures find particular use in applications where added stiffness is more critical than weight. Since the core of a composite sandwich structure is usually lighter than the resin impregnated face sheets, sandwich structures provide added stiffness at reduced weight.

However composite sandwich structures also exhibit a number of shortcomings. For example, in order to provide the same structural performance as their metallic counterparts composite sandwich structures need to be larger or thicker; constructing holes in thickness direction of the sandwich structure is undesirable, as it may significantly reduce the load bearing capacity of the over-all structure. Another shortcoming shown by sandwich panels is that their inter-laminar strength is usually poor in comparison with properties along the X-Y direction of the face sheet, the interply region being a typical area for easy crack expansion. Cracks can be caused by a wide variety of phenomena such as thermal effects, impact, the presence of holes or edges. Cracks severely reduce important properties of the composite laminate such as impact strength and impact resistance and the compressive strength, and they can lead to de-lamination and failure. Keeping face sheets adhered to the core in a sandwich structure has been problematic since the beginning and several techniques have been developed to solve this problem. Solutions include insertion of Z-pins or reinforcement fibres in Z-direction in the sandwich structure to increase pull-off strength of the face sheets under shear and reduce the risk to de-lamination. Known techniques for inserting such Z-direction reinforcement include stapling, needling, stitching, insertion of pins of resin impregnated reinforcement fibres. Although the Z-reinforcement may improve inter-laminar strength, it often causes deterioration of in-plane properties. It is thought that insertion of the Z-reinforcement causes kinking of the in-plane fibres of the top plies, thus creating significant strength loss in the material of the top plies. Besides that only a limited number of materials, in particular glass and Kevlar, is said to be suitable for use as Z-fibre material, because of the bending radii occurring in stitching. Insertion of reinforcing rods or thermosetting resin impregnated fibres in Z-direction by mechanical impact or similar tools is also known, but these techniques are labour intensive and costly when done manually and insufficiently fast when using machines.

WO03097335 discloses a method for producing a composite sandwich panel wherein opposite sides of a foam core are sandwiched between a first and second sheet of a fibrous reinforcing material. The core and first and second sheet are connected to each other by means of continuous reinforcing fibres, which extend in thickness direction of the panel and which are arranged in parallel rows of consecutive columns of connecting fibres. Consecutive columns of connecting fibres within a row are connected along the top and bottom face of the sandwich panel in the displacement direction of the panel through the device which inserts the connecting fibres. The sandwich panel is impregnated with resin using pultrusion, and the resin is hardened.

This known composite sandwich panel has been found to absorb moisture, which causes the weight of the sandwich panel to increase upon use, over time. This weight increase is undesired in applications where weight plays a crucial role, such as for example aviation, where increasing weight of panels used in separation walls will involve increasing fuel needs and decreasing load capacity.

It is therefore the object of the present invention to provide a method for producing a composite panel which shows a reduced risk to moisture absorption. It is also an object of the present invention to provide such a composite panel.

This object is achieved according to the present invention with a method for producing a composite panel, which shows the technical features of the characterizing portion of the first claim.

Thereto, the method of the present invention is characterized in that at least part of the core is removed after the connecting fibrous reinforcing material has been impregnated with resin and the resin has at least partly hardened.

The inventor has observed that the risk to water absorption by the composite panel and the extent to which water is absorbed by the panel may be reduced by removing at least part of the core. With a virtually completely removed core material, the risk to water absorption has been found to become negligible even over longer periods of time. Removal of the core material, being partial or virtually complete, presents the advantage of reducing the weight of the composite panel, whereas mechanical properties such as stiffness, strength, pressure and bending resistance and load bearing capacity may be maintained at a sufficient level. The resin impregnated connecting fibres connect the first and second sheet, they ensure that the first and second sheet are maintained at a desired distance from each other and provide or contribute to the desirable mechanical properties such as stiffness, strength, pressure and bending resistance and load bearing capacity.

In the method of this invention, the core functions as a kind of internal mould, which positions the first and second sheet of fibrous reinforcing material with respect to each other and maintains these sheets in that position in several stages of the sandwich panel production process, in particular
in the course of the process step wherein the connecting fibres are applied and the core and first and second sheet are connected to each other in thickness direction or Z-direction of the panel, to build a connected sandwich structure. The core provides the internal pressure resistance needed to maintain the first and second sheet in a spaced position in the process of applying the connecting fibres where the sheets are punched and a risk exists that they are moved from and towards each other, either locally or over larger parts of their surface;
in the course of the process step where the sandwich structure is impregnated with resin, to impregnate at least the first and second sheet and the connecting fibres with resin. Impregnation with resin usually involves a process where the sandwich structure is subjected to pressure, to inject resin and to cause the resin to flow through the sandwich structure. In this step, the core functions as an internal pressure medium or internal resistance to maintain the first and second sheet spaced from each other and to prevent the three dimensional structure comprising the first and second sheet of fibrous reinforcing material and connecting fibres, from collapsing upon impregnation with resin.
In the course of the process step where the resin impregnated sandwich structure is at least partly hardened to such an extent that the structure achieves a structural integrity which is sufficient to maintain the first and second sheet spaced from each other over the desired distance, by means of the resin impregnated connecting fibres.

The core further provides the medium which permits positioning the connecting fibres in X and Y direction of the sandwich panel at a desired position during the step of applying the connecting fibers. The core also provides the medium which permits maintaining the connecting fibres in their position during resin impregnation and hardening or curing of the resin. The core further provides flowing channels for the resin during resin impregnation and thereby determines the position of the resin during and after impregnation and after hardening or curing. The core thus contributes to the building of the supporting structure of the connecting fibres for the outer skins of the sandwich panel.

The presence of the core in other words permits building a sandwich structure, in which the first and second sheet are positioned at a predetermined distance from each other and maintained at a predetermined distance from each other. This positioning function is exerted by the core in the course of the process step where
(i) the connecting fibres are applied to connect core, first and second sheet,
(ii) the thus obtained structure is resin impregnated, to form columns of connecting fibers and unify the connecting fibers, the first and second sheet, with the purpose of forming a unified structure of the first and second sheet and the connecting fibers

Thereby the first and second sheet are positioned at a predetermined distance from each other and are maintained in that position, from the stage where the connecting fibres are applied to the stage where the sandwich structure is impregnated with resin. Once the resin has hardened to a sufficient extent, the core has fulfilled its principal function and it may be removed, either partly or fully.

According to the method of the present invention, the core is at least partly removed from the sandwich structure. Preferably however the core is substantially entirely removed from the sandwich structure.

U.S. Pat. No. 6,051,089 discloses a method for producing a composite reinforcing member capable of securing one or more reinforced composite pieces together. A plurality of fibrous reinforcing threads made of aramide or carbon fibre for example, are stitched at closely spaced apart locations through a removable polystyrene foam, thereby forming a grid of threads. On one side of the grid, common ends of the threads are secured together in the stitching operation and form an open mesh supporting structure. On the opposite side of the grid, the ends of the threads are free and are provided with sharp end parts. Impregnation of the threads with a thermosetting resin, which is cured, causes formation of a reinforcing grid with a plurality of generally straight pins after removal of the polystyrene foam. The pins are capable of penetrating a wide variety of materials which need to be reinforced, for example a perform.

In the method of the present invention the core is at least partly removed after the resin has hardened to such an extent that the at least partly hardened resin is capable of maintaining the position of the connecting fibrous reinforcing material and the first and second sheet of fibrous reinforcing material with respect to each other, to ensure that the position of the first and second sheet and the connecting fibers is maintained. In other words removal of the core is preferably carried out after an impregnated sandwich structure has been obtained with a sufficient structural rigidity. Preferably however, the core is removed only after the resin has largely or substantially entirely hardened or cured. After removal of the core a composite panel or composite structure remains which comprises a first and second sheet of fibrous material, which are resin impregnated and maintained at a well defined distance from each other by columns of resin impregnated connecting fibres, the first and second sheet forming one structural unity with the columns of resin impregnated connecting fibres. Thereby a space remaining between the columns of resin impregnated connecting fibres is at least partly substantially hollow, preferably hollow.

Removing of the core can be carried out using any technique considered suitable by the skilled person taking into account the nature of the core material that needs to be removed, the nature of the fibrous reinforcing material of the first and second sheet and of the connecting fibers and the nature of the resin used to impregnate the fibrous materials.

The present invention also relates to a composite panel mainly consisting of a kit of a first and a second sheet of a fibrous reinforcing material, positioned at a predetermined distance from each other and connected to each other by means of connecting fibres of fibrous reinforcing material, wherein the connecting fibres are impregnated with a resin which is at least partly hardened and wherein a core between the first and second sheet is at least partly removed. Such a composite sandwich panel is suitable for use in a wide variety of applications such as for example wall construction, for example walls for homes or transport media for example an airplane body, a container wall, separation wall. The above-described sandwich panel is also suitable for the construction of (temporary) landing strips for airplanes, the construction of bridge decks, for example the landing deck of an aircraft carrier etc.

### Sheets of Fibrous Reinforcing Material

In the composite panel of this invention, the first and second sheet of fibrous reinforcing material respectively form the first and second skin of the composite panel. The first and second sheet are preferably comprised of a woven material. In stead of a woven material, use can also be made of a non woven material. Suitable sheet materials include a fleece, a mat, a braiding of fibrous reinforcing material, or any other type of sheet material considered suitable by the skilled person. The first and second skin can be made of the same material, but they may also be made of different materials. The first skin may comprise one single layer of a sheet like material such as those described above, or of a combination of two or more sheet like materials positioned on top of each other, which may be the same or different. The second skin may also be made of one layer of a sheet like material as described above, or of a combination of two or more sheet like materials positioned on top of each other or interwoven or positioned in any other relationship, which may be the same or different.

Suitable materials for use in the first and second sheet of fibrous reinforcing material may be selected from the group comprising mineral fibres in particular glass fibre, plastic fibres for example polyolefin fibers, for example polyethylene, a polyester or a polyamide fibre, for example aramide, but also carbon fibres, metal fibres, natural fibres such as cotton, flax, or a combination of two or more of the afore-mentioned materials may suitably be used. The skilled person is capable of adapting the nature of the fibrous reinforcing material to the envisaged application of the composite sandwich panel and to the circumstances maintained during the production process of the panel. The fibrous reinforcing material is preferably chosen such that it is sufficiently stable and does not decompose or physically disintegrate in the circumstances in which the sandwich structure is impregnated with resin, in which the resin is hardened or the material of the core is removed.

### Core Materials

The present invention supposes that the core material is removed either partly or fully. Therefore, the material of the core may be selected such that it is easily removable or it may be selected in function of the technique used to remove the core. Thereby care needs to be taken that the material of the core is chosen such that it is capable of
performing the function of internal mould to keep the first and second sheet in a spaced apart position when applying the connecting fibres and impregnating the structure with resin,
functioning as a positioning member for the connecting fibres which connect the first and second sheet
being removed at minimum risk to adversely affecting the structure formed by the skin layers and the connecting fibres as well as the resin with which these materials are impregnated.
   Within the scope of this invention, depending on the envisaged application, it may be preferred either to provide a composite sandwich panel with a substantially completely removed core or a core which has been only partly removed.

The nature of the material used for the core is not critical to the invention. Suitable examples include foams of plastic materials as they may be easily penetrated by the connecting fibres. Suitable examples of plastic foam materials include foams of polyurethane, polypropylene, PVC, or any other material considered suitable by the skilled person. Examples of other suitable materials include honey rate materials made of plastic, wood or metal or a metal foam. However any other material deemed suitable by the skilled person may be used.

The material used for the core is selected such that it is sufficiently stable in circumstances, such as for example temperature and/or pressure at which the structure is impregnated with resin and the resin is hardened.

The core may be made of one single layer of one of the afore-mentioned materials. If so desired however, the core may be made of a plurality of layers of the same or different material, whereby subsequent layers may be connected to each other or not. Subsequent layers may be made of the same or different materials. Between subsequent layers, one or more layers of a fibrous reinforcing material may be inserted. It is also possible to use as a core material a plastic foam which is at least partly enveloped in a sheet of a fibrous reinforcing material, or a plurality of such adjacent enveloped cores, or a core material having opposite sides covered with a sheet of fibrous reinforcing material or any other reinforcing material.

The density of the material of which the core is made may be varied within wide ranges depending on the envisaged application. It has been observed that the density of the core should not be too high, to permit penetration of the core material by the connecting fibres and by any machine parts used to apply the connecting fibres, at minimum risk to damaging the connecting fibres and the machine parts. The inventor observed that impregnating and hardening or curing of the resin is preferably carried out under elevated pressure, as a result of which it may be advisable to select the density of the core in function of the process used to effectuate the resin impregnation, to provide sufficient pressure resistance in order to preserve the not yet rigidized structure formed by the first and second sheet which are connected by the connecting fibres.

Preferably the core material is chosen such that it is not too brittle to minimize the risk to breaking apart when applying the connecting fibres. It is further preferred that the material of the core is selected such that it does not or hardly react with the resin used to impregnate the structure, since this could affect the not yet rigidized structure of the connecting fibers which connect the first and second sheet. It is however not essential to the invention and a reaction between the material of the core and the resin may be acceptable and even be intended, depending on the result the skilled person seeks to achieve.

The dimensions of the core are preferably chosen in such a way that they provide the desired distance between the first and second sheet.

The material of the core may provide additional properties to the composite panel, such as fire resistance, fire retardance, insulating properties etc. These may play a role during production of the composite panel, but also in the finished panel and in this case it could be decided to only remove part of the core.

Preferred materials used as a core material include those which may be partially or substantially entirely removed from the composite panel by for example chemical reaction or decomposition, dissolution, physical removal, or a combination of two or more of these methods. Preferably the removal of at least part of the core does not substantially affect the fibrous reinforcing material of the connecting fibers and the sheet layers as well as the resin used to impregnate them. Representative materials include those which are soluble in a solvent, for example water, more in particular a polar, such as water, or an apolar solvent. Thereby solvent and core material are preferably selected such that there is a negligible risk that the solvent would adversely affect the fibrous reinforcing material of the connecting fibres and the sheet layers as well as the resin used to impregnate them. To remove the core according to this embodiment, the composite panel is contacted with the solvent after the fibrous reinforcing structure has been impregnated with resin and hardened to a sufficient extent to provide sufficient structural rigidity so that the structure of the first and second sheet and connecting fibres is maintained in the desired way, and kept in contact with the solvent until the desired amount of core material is removed. According to another preferred embodiment of the method of this invention, as a core material use can be made of a material that decomposes upon heating or contact with oxygen or another gas. This way for example a material can be chosen with a decomposition temperature or melting temperature which is above the temperature at which the resin is hardened, but below the temperature at which the resin melts or decomposes, and below the temperature at which the fibrous reinforcing material is affected or melts or decomposes. Examples of such materials include powders of solid plastic materials, the grains of which adhere to another upon heating to a first temperature, whereby the material disintegrates again upon further heating to a higher temperature. Other materials suitable for use as the core include those which may be removed when subjected to pressure, for example to jets of pressurized liquid, for example water, jets of powdery solid material for example sand or silica, or jets of pressurized gas for example air, CO₂, N₂, etc. Furthermore it is possible to subject the core to jets of solid CO₂ under high pressure at low temperature. Preferably however the core is removed using a method which shows a limited risk to damaging or adversely affecting the structure and material of the fibrous reinforcing material of the sheets and the connecting fibres as well as that of the resin with which these had been impregnated. A combination of two or more techniques may be used as well if the materials or the circumstances so require.

Within the scope of this invention it may be envisaged to remove the core material in part of the structure and leave it unaffected in another part of the composite sandwich panel; it may also be envisaged to remove layers of core material, for example in a direction parallel to the first and second skin; it may further be envisaged to leave some core material around the columns of resin impregnated fibers.

### Connecting Fibres

In the composite panel of this invention, the first and second sheet of fibrous material and the core are connected to each other by means of connecting fibrous reinforcing material, preferably fibres, i.e. connecting fibres, of such connection fibrous reinforcing material, which preferably extend in thickness direction Z, or height direction of the sandwich panel. Connecting fibres may be applied over the entire sandwich panel or over only part thereof. The density with which the connecting fibres is applied may be constant over the panel or it may vary. This means that fibres may be arranged as single columns which extend in thickness direction of the sandwich panel, or as pairs or as groups of three, four or more columns of fibres. Varying the number of fibres permits varying the strength of the local reinforcement.

For example, the number of fibres per column of fibres can be chosen in function of the desired characteristics of the composite panel according to the present invention.

For example, the number of columns of fibres, for example per area of composite panel, can be chosen in function of the desired characteristics of the composite panel according to the invention. The density of columns of fibres per area, for example the number of columns per square meter, preferably is kept as low as can be allowed by the desired characteristics of the composite panel to decrease the weight of the composite panel according to the invention and to decrease the amount of fibrous material necessary for making the composite panel.

Generally the amount of fibrous reinforcing material of the composite panel according to the invention, which extends in thickness direction can be expressed as a percentage of the weight of the total amount of fibrous material. The total amount of fibrous material includes the sheets of fibrous reinforcing material and the connecting fibrous reinforcing material. Preferably, the percentage of fibrous reinforcing material extending along thickness direction with respect to the total amount of fibrous material present in the composite panel is between 1% and 10%, preferably between 1% and 5%, more preferably between 2% and 3%, often around about 2.5%. The inventors have observed that with the method of the present invention a composite panel may be produced in which the content of fibrous material present in connecting fibrous is significantly less with respect to existing products, while a good load bearing capacity, bending resistance and bending strength is maintained. This is important in relation to the weight of the panel, as resin accumulates at the position of the fibrous reinforcing material.

After having been impregnated with resin, the connecting fibres provide a plurality of columns which extend between the first and second sheet. End parts of adjacent columns are connected to each other along at least one direction, along at least one, but preferably both of the first and second sheet of the composite sandwich panel. According to a preferred embodiment, connecting fibers are applied as a plurality of rows of connected columns of connecting fibers, which may run parallel or not. Connecting fibers may engage the face of the first and/or second sheet facing the core, or pointing away from the core or any position there between. In practice, adjacent columns of connecting fibres are mostly connected in the direction in which the sandwich structure of core material and first and second sheet, are displaced through the device which applies the connecting fibers. Usually this will be the longitudinal direction of the sandwich structure. It is however also possible to connect adjacent columns of connecting fibres in two or more directions, in X- and/or Y direction of the panel and/or one or more additional directions. Although adjacent columns will preferably be connected to each other, local interruptions may occur in the connection. Usually such local interruptions will not significantly influence the mechanical properties of the sandwich panel. If so desired, locally, connection of adjacent columns of connecting fibres may be dispensed with in order to provide a sandwich panel with controlled, locally varying mechanical properties. The connection of the connecting fibres along the surface of the first and/or second sheet permits achieving a significant improvement of the mechanical properties of the sandwich panel.

The connecting fibres may extend mainly in height direction or Z-direction of the composite sandwich panel. Thereby the connecting fibres may extend substantially parallel to the upright side walls of the composite panel or along one or more angles with respect thereto in order to further improve the mechanical properties and pressure resistance and load bearing capacity of the sandwich panel. Connecting fibres may for example extend under an angle of 30°, 45° or 60° with respect to the upright side walls of the composite panel, or under any other angle considered appropriate and useful by the skilled person or under two or more different angles. Within the scope of the present invention it is also possible that connecting fibres extend under two or more different angles with respect to the upright side walls of the panel. The angle under which the connecting fibres extend may vary over the panel.

If so desired, discrete connecting fibres may be used for connecting the first and second sheet, which take the shape of individual non-connected columns, but preferably substantially continuous fibres are used. Examples of suitable continuous fibrous reinforcing materials include a tow, a yarn, a string, a tape, etc. Examples of materials which may suitably be used as continuous reinforcing fibres, are described above and include mineral fibres for example glass fibre, plastic fibres for example a polyethylene, a polyester or a polyamide fibre, for example aramide, carbon fibres, metal fibres, natural fibres such as cotton, flax, or a combination of two or more of the afore-mentioned materials.

To apply the connecting fibers, any technique considered suitable by the skilled person may be used. Suitable techniques for applying continuous connecting fibers include needling, stitching, tufting, braiding or any technique derived from one of those. If so desired a combination of two or more of the afore mentioned techniques may be used as well. Usually use will be made of a technique wherein the first sheet, the core and the second sheet are punched to form a channel for receiving the connecting fibre and also the resin in the course of the impregnation step. The use of these techniques in combination with continuous connecting fibres involves that adjacent, subsequent columns of connecting fibres get connected with each other in the direction in which the sandwich structure is moved throughout the connecting fibre application device. Some of the afore-mentioned connecting techniques can be operated using automated devices, in a continuous operated system. A suitable technique for applying discontinuous connecting fibres is for example disclosed in U.S. Pat. No. 3,647,606 and U.S. Pat. No. 5,741,574. According to a first method disclosed in these patent publications, thin columns with one or more filaments, partly coated with resin connect the filaments to the sheet material.

Unification of the first and the second sheet and the connecting fibres into one structure may be achieved by impregnation of the fibrous materials with resin. The nature of the resin is not critical to the invention and will usually be adapted to the nature of the envisaged application and the device used to apply the resin. Suitable resins include thermosetting and thermoplastic resins. Examples of suitable resins include unsaturated polyesters, vinyl ester resins, epoxy resins, phenol resin, polyurethane resin. The resin is preferably selected such that it does not chemically react with the core material nor with the fibrous reinforcing material. Impregnation of the fibrous reinforced sandwich structure may be achieved with any technique considered suitable by the skilled person, for example pultrusion or impregnation in a mould. Preferably however pultrusion is used.

According to a preferred method for producing the sandwich panel of the present invention, at least one first and second sheet of fibrous reinforcing material are supplied on opposite sides of a core. If so desired a further core material may be positioned on top of the second sheet, the face of the second core pointing away of the second sheet being covered by a third sheet of fibrous reinforcing material. In a similar way additional core materials and fibrous reinforcing sheets may be added.

The core and the at least one first and second sheet of fibrous reinforcing material are connected to each other using a suitable technique, for example needling, stitching, tufting, braiding or a technique derived from one of these or a combination of two or more of these techniques. However, any other equivalent technique may be used. Preferably a technique is used wherein the first and second sheet and the core are punched to provide a channel through which the connecting fibers are drawn when connecting the first and second sheet. When punching the sandwich structure, the sandwich structure is preferably not subjected to a displacement. After the punching step has been carried out, the sandwich structure is forwarded through the device. This procedure permits reducing the risk to the formation of large holes in the core, which would adversely affect the positioning of the connecting fibres and create large spaces for receiving resin. This would in turn increase the weight of the sandwich structure. In case several layers of fibrous reinforcing material and core material are used, it may be advantageous to either connect all layers in one go or to separately connect pairs of layers.

The connection of respectively the first and the second sheet with the core may be accomplished in separate process steps. The connection is preferably accomplished in one process step as this provides an economically feasible process.

The thus connected structure of the core and the first and second sheet is impregnated with a resin as described above, to unify the first and second sheet of fibrous reinforcing material and the connecting fibres. A particularly suitable process for impregnating the sandwich structure with resin is pultrusion, wherein the sandwich structure is moved through the pultrusion die as the structure is not penetrated by the needles. The resin is supplied under pressure and penetrates the first and second sheet of fibrous reinforcing material and the connecting fibers while pressurized. The impregnated structure is forwarded and, in case use is made of a thermosetting resin, heated to cure the resin.

In a next step, the material of the core is removed, either partly or substantially completely.

The present invention thus provides a method for producing a honey-rate like structure wherein the distance between adjacent layers of sheets of fibrous reinforcing material may be kept virtually constant over the whole structure or may be varied, by varying the thickness of the core. Adjacent sheets may be connected by sheets of fibrous reinforcing material in combination with connecting fibres or exclusively by connecting fibres. This way structures may be provided which are more or less open, wherein mechanical properties as strength, rigidity and load bearing capacity vary as a function of the position within the structure.

1. A method for producing a composite sandwich panel wherein a core is inserted between a first and a second sheet of a fibrous reinforcing material, wherein the first and the second sheet and the core are connected to each other by means of connecting fibrous reinforcing material to produce a sandwich structure, wherein the sandwich structure is impregnated with a resin, characterised in that at least part of the core is removed after the connecting fibrous reinforcing material has been impregnated with resin and the resin has hardened at least partly.

2. A method according to claim 1, characterised in that at least part of the core is removed after the resin has hardened to such an extent that the at least partly hardened resin is capable of maintaining the position of the connecting fibrous reinforcing material and the first and second sheet of fibrous reinforcing material with respect to each other.

3. A method according to claim 2, characterised in that the core is removed after the resin has hardened substantially completely.

4. A method according to claim 1, characterised in that the core is removed using a method from the group of chemical reaction or decomposition, dissolution, physical removal, or a combination of two or more of these methods.

5. A method according to claim 1, characterised in that the composite panel is impregnated with a curable thermosetting resin or a thermoplastic material.

6. A method according to claim 1, characterised in that the connecting fibrous material for connecting the first sheet, the core and the second sheet, are applied using a method selected from the Group of stitching, needling, braiding, tufting, or a combination of two or more of these techniques.

7. A method according to claim 6, characterised in that the connecting fibres comprise continuous fibrous reinforcing material.

8. A method according to claim 1, characterized in that the weight ratio of the connecting fibres which extend along thickness direction of the composite panel with respect to the total amount of fibrous reinforcing material in the composite panel is between 1 wt. % and 10 wt. %, preferably between 1 wt. % and 5 wt. %.

9. A composite sandwich panel mainly consisting of a kit of a first and a second sheet of a fibrous reinforcing material, positioned at a predetermined distance from each other and connected to each other by means of connecting fibres of fibrous reinforcing material, wherein the connecting fibres are impregnated with a resin which is at least partly hardened and wherein a core between the first and second sheet is at least partly removed.

10. A composite sandwich panel according to claim 9, characterised in that the connecting fibres penetrate the first and second sheet at least partly.

11. A composite sandwich panel according to claim 9, characterized in that the weight ratio or the connecting fibres which extend along thickness direction of the composite panel with respect to the total amount of fibrous reinforcing material in the composite panel is between 1 wt. % and 10 wt. %, preferably between 1 wt. % and 5 wt. %.

12. A composite sandwich panel according to claim 9, characterised in that at least part of the space between the first and second sheet is empty of core material.

13. A composite panel according to claim 9, obtained with the method according to claim 1.
